(19) United States
(12) Patent Application Publication
(10) Pub. No.: US 2025/0232760 A1
(43) Pub. Date: Jul. 17, 2025

(54) METHOD AND SYSTEM FOR AUTOMATICALLY GENERATING A TARGET MEDIA

(71) Applicant: InMobi Pte Ltd., Singapore (SG)

(72) Inventors: Ritesh Ghodrao, Bangalore (IN); Ankit Mittal, Irvine, CA (US)

(73) Assignee: InMobi Pte Ltd., Singapore (SG)

(21) Appl. No.: 19/021,769

(22) Filed: Jan. 15, 2025

Related U.S. Application Data
(60) Provisional application No. 63/621,271, filed on Jan. 16, 2024.

(51) Int. Cl. G10L 13/027; G06Q 30/0251

(52) U.S. Cl. CPC G10L 13/027; G06Q 30/0251

(57) ABSTRACT

The present disclosure relates to a method and system for automatically generating a target media. The method comprises receiving, by a processing unit, at least one of a media content data, an entity data, and one or more target audience parameters. Also, the method comprises generating, by the processing unit, a background music based on at least one of the media content data, the entity data, the one or more target audience parameters, and a transcript. Further, the method comprises generating, by the processing unit an audio speech based on at least one of the media content data, the entity data, the one or more target audience parameters, the transcript, and the background music. Thereafter, the method comprises generating automatically, by the processing unit, the target media based on at least the background music, and the audio speech.

### CROSS REFERENCE TO RELATED APPLICATION

This application claims the benefit under 35 U.S.C. § 119 (e) of U.S. Provisional Patent Application No. 63/621,271, filed Jan. 16, 2024, the entire contents of which are incorporated herein by reference.

### TECHNICAL FIELD

The present disclosure generally relates to the field of information technology. Particularly, the present disclosure relates to methods and systems of media generation. More particularly, the present disclosure relates to methods and systems for automatically generating a target media.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as an admission of the prior art.

In today's fast-changing and technology-driven world the competition between companies to keep producing new products and/or services for their existing consumers as well as to attract new consumers, has increased. The companies are always coming up with new and creative things for their consumers (or may also be referred to as customers), as needs, preferences and choices of the consumers are increasing and changing. Further, online shopping has opened the doors for the companies to operate globally resulting in more competition and challenges. Also, the consumers now have so many different options to choose from, which is good for them, but for the companies it has further increased the competition and made it hard for them to get noticed.

This is where an advertisement (ad) plays a crucial role. The advertisement is like a bridge between the companies and their potential customers. The companies use ad(s) to make the potential customers aware of their brands, products, services, and show the potential customers what makes their products special and/or different from the others. Further, at a same time the ad(s) convince the potential customers to buy or purchase specific products or services. Also, it is important on the part of companies to manage their budgets for ad(s) well so they can compete with other companies and make their ad campaigns successful.

Additionally, the ad(s) affect cost and price of products and services provided by a company. Therefore, using smart and targeted strategies for the ad(s) can save money of the companies while still making sure customers (existing and/or potential customers) see their ad(s), especially if the strategies are based on data related to preferences of the existing customers and the potential customers. Further, the ad(s) can be in numerous forms such as, but not limited to, videos and audio clips, newspaper clippings, magazine clippings, billboards, etc. However, the ad(s) in videos and audio clips format are more popular now a days as they make potential customers feel more connected to corresponding products, services and even the companies offering those products and services. Since people now a days are consuming a lot of different types of audio-video media, using these kinds of ad(s) is a great way for the companies to make their brands stick in minds of the people such as potential customers and build loyalty with both the existing customers and the potential customers.

Further, existing solutions for generating audio advertisements or audio-visual advertisements is riddled with various shortcomings that hinder its efficiency and cost-effectiveness. One major drawback of the existing solutions is a high production cost associated with creating an audio content or an audio-visual content. This cost further increases significantly when multiple variations are required to target specific audience segments based on language, demographics, and other factors. Additionally, sourcing copyright-free audio clips to use as fillers or background music poses a challenge, adding to the complexity and expense of the process. Moreover, the current solutions personalization capabilities are limited, as it only allows for the addition of a user's name to a script of an ad to be provided to the user. This lack of versatility restricts a level of personalization that can be achieved, thereby diminishing impact of the ad(s) on an individual potential consumer. Surprisingly, no existing solutions provide an end-to-end audio advert generation, encompassing both the script and a background music seamlessly. Furthermore, another existing solution resort to employing vocal artists or audio-mixing tools to generate voice-overs for pre-defined scripts, which can be both time-consuming and costly. This process lacks automation and adaptability required to efficiently cater to diverse marketing campaigns and audiences. In conclusion, the current solutions for generating the audio advertisements or the audio-visual advertisement faces numerous challenges related to cost, personalization, and efficiency. The need for a more comprehensive and automated approach that addresses these shortcomings has become evident. A solution that can generate complete audio adverts, including dynamic script generation and diverse background music choices, would significantly enhance the effectiveness and affordability of audio advertising in the modern market.

Therefore, there are a number of limitations to the existing solutions and in order to overcome these and such other limitations of the known solutions it is necessary to provide an efficient solution for automatically generating a target media such as an audio advertisement or an audio-visual advertisement.

### SUMMARY

This section is provided to introduce certain aspects of the present disclosure in a simplified form that are further described below in the detailed description. This summary is not intended to identify the key features or the scope of the claimed subject matter.

An aspect of the present disclosure relates a method for automatically generating a target media. The method comprises receiving, by a processing unit, at least one of a media content data, an entity data, and one or more target audience parameters. Also, the method comprises generating, by the processing unit, a background music based on at least one of the media content data, the entity data, the one or more target audience parameters, and a transcript. Further, the method comprises generating, by the processing unit, an audio speech based on at least one of the media content data, the entity data, the one or more target audience parameters, the transcript, and the background music. Thereafter, the method comprises generating automatically, by the processing unit, the target media based on at least the background music, and the audio speech.

In an exemplary aspect of the present disclosure, the target media is one of an audio advertisement (ad) and an audio-visual ad.

In an exemplary aspect of the present disclosure, the media content data comprises at least one of an advertisement data and one or more input parameters.

In an exemplary aspect of the present disclosure, the one or more input parameters are received in a manual input, and the one or more input parameters comprise at least one of one or more media tone parameters, an input time duration parameter, and one or more action call parameters.

In an exemplary aspect of the present disclosure, the entity data is a data related to one or more entities, and wherein each entity from the one or more entities is one of a brand entity and a product entity.

In an exemplary aspect of the present disclosure, the entity data comprises at least one of an entity name of the one or more entities, an entity description of the one or more entities, one or more keywords associated with the one or more entities, and an URL associated with the one or more entities.

In an exemplary aspect of the present disclosure, the one or more target audience parameters comprise at least one of a target gender parameter and a target age group parameter.

In an exemplary aspect of the present disclosure, the transcript is generated based on at least one of the media content data, the entity data, and the one or more target audience parameters.

In an exemplary aspect of the present disclosure, the method further comprises utilizing, by the processing unit, one or more artificial intelligence (AI) based language models for generating the transcript, one or more AI based text-to-audio models for generating the background music, and one or more AI based text-to-speech models for generating the audio speech.

In an exemplary aspect of the present disclosure, the audio speech is generated in one or more voice types, wherein the one or more voice types comprises at least one of a male voice type, a female voice type and a child voice type.

In an exemplary aspect of the present disclosure, the target media is generated in a predefined format based on merging in a predefined manner the generated background music and the generated audio speech.

In an exemplary aspect of the present disclosure, the method further comprises: 1) generating a script, by the processing unit, based on one or more predefined protocol standards and the target media, wherein the script comprises a data related to one or more media files, and a pre-defined tag of each media file from the one or more media files, and 2) streaming, by the processing unit to one or more user devices, the target media based on the script.

In an exemplary aspect of the present disclosure, the script is related to at least one of a set of bitrates, a set of media, and a set of uniform resource locators (URLs).

In an exemplary aspect of the present disclosure, a predefined protocol standard from the one or more predefined protocol standards is a Video Ad Serving Template (VAST) protocol standard.

Another aspect of the present disclosure relates to a system for automatically generating a target media. The system comprises a processing unit and a storage unit connected to at least the processing unit. The processing unit is configured to receive, at least one of a media content data, an entity data, and one or more target audience parameters. The processing unit is also configured to generate, a background music based on at least one of the media content data, the entity data, the one or more target audience parameters, and a transcript. Further, the processing unit is configured to generate, an audio speech based on at least one of the media content data, the entity data, the one or more target audience parameters, the transcript, and the background music. Furthermore, the processing unit is configured to generate automatically, the target media based on at least the background music, and the audio speech.

Yet another aspect of the present disclosure relates a non-transitory computer readable storage medium storing one or more instructions for automatically generating a target media, the instructions include executable code which, when executed by one or more units of a system, causes a processing unit of the system to receive, at least one of a media content data, an entity data, and one or more target audience parameters. Also, the executable code when executed causes the processing unit to generate, a background music based on at least one of the media content data, the entity data, the one or more target audience parameters, and a transcript. Further, the executable code when executed causes the processing unit to generate, an audio speech based on at least one of the media content data, the entity data, the one or more target audience parameters, the transcript, and the background music. Thereafter, the executable code when executed causes the processing unit to generate automatically, the target media based on at least the background music, and the audio speech.

### OBJECTS OF DISCLOSURE

Some of the objects of the present disclosure which at least one embodiment disclosed herein satisfies are listed herein below.

It is an object of the present disclosure to provide a system and a method for automatically generating a target media (e.g., audio advertisement or audio-visual advertisement).

It is another object of the present disclosure to provide a solution to generate personalised audio media i.e., audio advertisement (ad) or a personalised audio-visual media i.e., audio-visual ad based on manual input(s) from a backend operator.

It is another object of the present disclosure to provide a solution to generate a script, using an artificial intelligence (AI) based model, based on a target audience of the target media and the manual input(s) from the backend operator.

It is another object of the present disclosure to provide a solution to automatically generate a background music, using an AI based model, based on the manual input(s) from the backend operator and/or the script for the target media.

It is another object of the present disclosure to provide a solution to produce natural and human-like speech, using an AI based model, based on the manual input(s) from the backend operator and/or the script for the target media.

It is yet another object of the present disclosure to provide a solution to automatically integrate a speech and a background music to generate the target media.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the disclosure. All sub-components within a component may be connected to each other, unless otherwise indicated.

FIG. 1 illustrates an exemplary block diagram of a system for automatically generating a target media, in accordance with the exemplary embodiments of the present disclosure.

FIG. 2 illustrates an exemplary flow diagram of a method for automatically generating a target media, in accordance with the exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter may each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a (Digital Signal Processing) DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor. Furthermore, to execute certain operations, the processing unit/processor as disclosed in the present disclosure may include one or more Central Processing Unit (CPU) and one or more Graphics Processing Unit (GPU), selected based on said certain operations. Furthermore, the graphics processing unit (GPU) is a specialized electronic circuit designed to rapidly manipulate and alter a memory to accelerate the creation of images in a frame buffer intended for output to a display device.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit can be any type of storage unit such as cloud storage, public, shared, private, telecommunications operator-based storage, or any other type of storage known in the art or may be developed in future that may be obvious to a person skilled in the art for implementing the features of the present disclosure. The storage unit stores at least the data that may be required by one or more units of a server/system/user device to perform their respective functions.

A ‘smart computing device’ or ‘user device’ refers to any electrical, electronic, electromechanical equipment or a combination thereof. Smart computing devices may include, but not limit to, a mobile phone, smart phone, pager, laptop, a general-purpose computer, desktop, personal digital assistant, tablet computer, mainframe computer, smart television, gaming consoles, media streaming devices, or any other computing device as may be obvious to a person skilled in the art for implementing the features as disclosed in the present disclosure. In general, a smart computing device is a digital, user configured, computer networked device that can operate autonomously. A smart computing device is one of the appropriate systems for storing data.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

As discussed in the background section, the current known solutions have several shortcomings. Currently, in the existing solutions a production cost associated with creation of a target media e.g., an audio content or an audio-visual content is very high. Further, this production increases when multiple variations of the target media are required for target specific audience segment(s). The target specific audience segment(s) are formed on the basis of language, demographics, and such other factors. Additionally in the existing solution, sourcing copyright-free audio clips to be used as fillers or background music poses another challenge, as it is complex and expensive. Further, the existing solution lacks a level of personalization that can be achieved, thereby diminishing the impact of an advertisement on an individual customer (includes both the existing customers and the potential customers). Furthermore, the existing solutions relies on employing vocal artists or audio-mixing tools to generate voice-overs for pre-defined script(s), which can be both time-consuming and costly. Moreover, the existing solutions lack the capability of automation and adaptability required to efficiently cater to diverse marketing campaigns and audiences.

The present disclosure aims to overcome the above-mentioned and other existing problems in this field of technology by automatically generating a target media such as audio advertisements (ads) or audio-visual ads. Further, for generating the target media, the solution as disclosed in the present disclosure includes receiving at least one of a media content data, an entity data, and one or more target audience parameters. Further, the present solution utilizes an artificial intelligence (AI) based language model to generate an engaging transcript based on at least one of the media content data, the entity data, and the one or more target audience parameters. Further, the solution as disclosed in the present disclosure includes generating a suitable background music for the target media that enhances the impact of the target media. This background music is generated, using an AI based text-to-audio model, based on at least one of the media content data, the entity data, the one or more target audience parameters, and the generated transcript. Furthermore, the solution disclosed in the present disclosure includes generating high-quality, natural-sounding and human-like audio speech that adapts to a script of the target media (i.e., an Ad) that is to be generated, making the listening experience authentic and captivating. The audio speech is generated, using an AI based text-to-speech model, based on at least one of the media content data, the entity data, the one or more target audience parameters, the generated transcript, and the generated background music. Thereafter, the solution disclosed in the present disclosure includes a harmonious merger of the audio speech with the background music that enhances the professional output of the generated target media.

Therefore, the present disclosure provides a technical solution for generating the target media such as, but not limited to, an audio ad and an audio-visual ad. The present solution efficiently and significantly reduces the time and resources required to create personalized media, providing a scalable and versatile solution for advertisers across various industries. More specifically, technical solution as disclosed in the present disclosure is a transformative enhancement in generation of personalised media such as the audio or audio-visual advertisement, empowering advertisers to effectively communicate their brand messages and improve brand engagement and conversion rates.

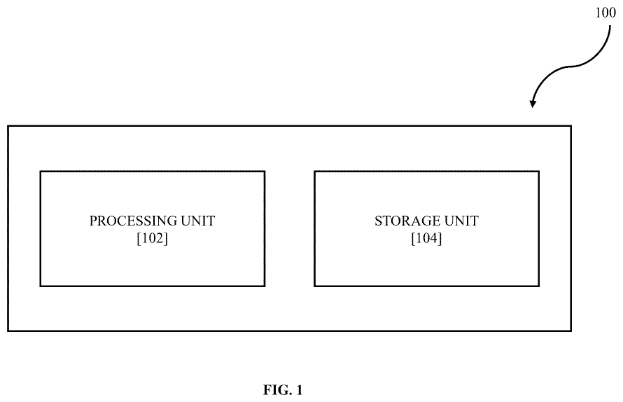

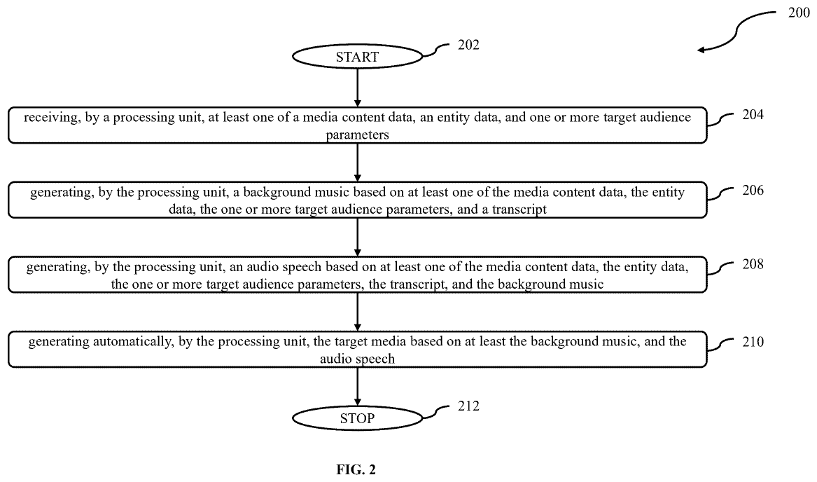

The manner in which a target media is generated is explained in detail with respect to FIGS. 1-2. It is to be noted that drawings of the present subject matter shown here are for illustrative purposes and are not to be construed as limiting the scope of the subject matter claimed.

Referring to FIG. 1 an exemplary block diagram of a system for automatically generating a target media, in accordance with the exemplary embodiments of the present disclosure is illustrated. The system comprises at least one processing unit and at least one storage unit [104]. Also, all of the components/units of the system are assumed to be connected to each other unless otherwise indicated below. Also, in FIG. 1 only a few units are shown, however, the system may comprise multiple such units or the system may comprise any such numbers of said units, as required to implement the features of the present disclosure. In an implementation, the system may reside in a server, or the system may be connected to the server.

In operation, for automatically generating a target media, the processing unit is configured to receive at least one of a media content data, an entity data, and one or more target audience parameters. In an implementation, upon receiving an indication for automatically generating a target media, the processing unit is configured to automatically receive from a storage unit such as the storage unit [104], at least one of the media content data, the entity data, and the one or more target audience parameters. In another implementation, the processing unit is configured to manually receive, (e.g., as one or more manual inputs from a backend operator of the system [100]) at least one of the media content data, the entity data, and the one or more target audience parameters. Also, the target media is one of an audio advertisement (ad) and an audio-visual ad.

Further, the media content data comprises at least one of an advertisement data and one or more input parameters. The advertisement data includes data related to an advertisement (ad) that is collected from one or more sources. The one or more sources may include such as, but not limited to, a customer relation management system, a sales data, one or more e-commerce platforms, one or more social media platforms, and/or such other sources as appreciated by a person skilled in the art in light of the present disclosure. Further, the collected data are analyzed to understand how well the ad is performing and optimize the ad. Also, the data collected from the one or more sources may include such as, but not limited to, an information related to at least one of a target audience, preference(s) of the target audience, an interest of the target audience in the ad(s), an interaction of the target audience with the ad(s) and such other data as appreciated by a person skilled in the art in light of the present disclosure.

Further, the one or more input parameters are received in a manual input, and the one or more input parameters comprise at least one of one or more media tone parameters, an input time duration parameter, and one or more action call parameters. The one or more media tone parameters include such as, but not limited to, at least one of an upbeat tone, an energetic tone, a wholesome tone, a dark tone, a normal tone, and a sad tone, etc. Further, the input time duration parameter includes time duration such as, but not limited to, 10 sec, and/or 20 sec, etc., for generating a transcript for the target media to be generated and the one or more action call parameters includes such as, but not limited to, at least one of a learn more action, a download now action, a click action, and a know more action, etc.

It is to be noted that the abovementioned the one or more media tone parameters, the input time duration parameter, and the one or more action call parameters are only exemplary and in no manner limiting the scope of the present disclosure. The one or more media tone parameters, the input time duration parameter, and the one or more action call parameters may include any other parameter(s) as appreciated by a person skilled in the art in light of the present disclosure.

Further, the entity data is a data related to one or more entities. The entity data may include data related to a market performance of the one or more entities or the data related to the performance of the one or more entities within the customers of the one or more entities. Each entity from the one or more entities is one of a brand entity and a product entity. Also, the entity data comprises at least one of an entity name of the one or more entities, an entity description of the one or more entities, one or more keywords associated with the one or more entities, and an URL associated with the one or more entities. Furthermore, the one or more target audience parameters comprise at least one of a target gender parameter (such as, male and/or female etc.) and a target age group parameter (such as 18-25 years, 30-35 years, and/or 50 years and above etc.).

Once the processing unit receives at least one of the media content data, the entity data, and the one or more target audience parameters, the processing unit is further configured to generate, a background music based on at least one of the media content data, the entity data, the one or more target audience parameters, and a transcript. The transcript is generated based on at least one of the media content data, the entity data, and the one or more target audience parameters. Also, the processing unit utilises one or more artificial intelligence (AI) based language models to generate the transcript. For instance, in an implementation, the AI based language models may receive at least one of the media content data, the entity data, and the one or more target audience parameters in an audio format. The AI based language converts said received at least one of the media content data, the entity data, and the one or more target audience parameters into a textual format from the audio format. The converted textual format of said at least one of the media content data, the entity data, and the one or more target audience parameters may be used to generated at least one of the background music and an audio speech for the target media to be generated.

It is to be noted that the abovementioned audio format of at least one of the media content data, the entity data, and the one or more target audience parameters is only exemplary and in no manner limiting the scope of the present disclosure. Said at least one of the media content data, the entity data, and the one or more target audience parameters may be received in any other format as appreciated by a person skilled in art to implement the features of the present disclosure.

In an implementation, the transcript may be generated based on the one or more target audience parameters in a predefined text format comprising at least one or more keywords associated with the one or more entities. Considering an example, say a clothing brand wants to advertise its products. The brand particularly wants to target its female buyers between the age of 18-25 years. So, the target gender parameter is female, and the target age group parameter is 18-25 years. The AI based language model may receive said target gender parameter and said target age group parameter as an input (either automatically or manually), in an audio format. The AI based language model generates a transcript in a textual format based on said inputs by converting the said audio inputs into the textual format and this textual format of the inputs may be further used to generate at least one of the background music and an audio speech for the target media to be generated.

In another exemplary implementation of the present solution, the transcript may be generated for a predefined length based on at least the input time duration parameter. Considering an example, the AI based language model generates the transcript of maximum 500 words based on the time duration of, say, 1 minute received as the input time duration parameter.

In an implementation, the processing unit utilizes one or more AI based text-to-audio models for generating the background music. In an implementation, the background music may be generated based on at least one of a desired media tone parameter, the target age group parameter, and the input time duration parameter. For example, an upbeat background music of 1 minute is generated for the transcript generated of maximum 500 words based on the received input time duration parameter for e.g., the time duration of 1 min, the target gender parameter female audience and target age group parameter 18-25 years as discussed in the abovementioned example.

Further, the processing unit is configured to generate, an audio speech based on at least one of the media content data, the entity data, the one or more target audience parameters, the transcript, and the background music. The processing unit utilizes one or more AI based text-to-speech models for generating the audio speech. The audio speech is generated in one or more voice types, wherein the one or more voice types comprises at least one of a male voice type, a female voice type and a child voice type. Considering the abovementioned example, the audio speech may be generated in a young female voice type as the target gender parameter is female and target age parameter is 18-25 years.

Once the background music and the audio speech are generated, the processing unit is furthermore configured to generate automatically, the target media based on at least the background music, and the audio speech. The target media is generated in a predefined format based on merging in a predefined manner the generated background music and the generated audio speech. The generated background music and the generated audio speech are merged in such a manner that a volume of the generated background music is lower than a volume of the generated audio speech so the focus of the target audience of the target media remains on the generated audio speech instead of the generated background music. Considering the abovementioned example, the target media, for the clothing brand targeting the females of the age group 18-25 years, is generated in the predefined format such as the target media is of maximum 4 Megabytes in size. It may have at least 320 kilobits per second media playback speed and the volume of the generated background music in the target media is lower than the volume of the generated audio speech in the target media (i.e., the volume of the upbeat background music is lower than the volume of the audio speech of the young female). The focus of the target audience i.e., the females of the age group 18-25 years remain on the generated audio speech in the target media, e.g., the young female voice stating, say, “Fashion for the modern woman. Shop now and find your perfect style.”

Moreover, the processing unit is configured to generate, a script based on one or more predefined protocol standards and the target media. The script comprises a data related to one or more media files, and a pre-defined tag of each media file from the one or more media files. Further, the script is related to at least one of a set of bitrates, a set of media, and a set of uniform resource locators (URLs). Also, a predefined protocol standard from the one or more predefined protocol standards is a Video Ad Serving Template (VAST) protocol standard.

Also, the processing unit is configured to stream, to one or more user devices, the target media based on the script. Further, the one or more media files with the pre-defined tag(s) can be used directly to stream the one or more media files. Further, parser(s) such as an XML parser etc. may be used to generate a final output tag along with the one or more media files for the set of bitrates, companion image(s), and/or tracking URL(s).

In an implementation, the generated script may provide audio file(s), along with a VAST tag which may be directly used for advertising with an audio ad. Also, the XML parser(s) for VAST XML(s) may be used to generate a final output tag along with the audio file(s) for the set of bitrates, companion image(s), and/or tracking URL(s).

Referring to FIG. 2 an exemplary flow diagram of a method for automatically generating a target media, in accordance with the exemplary embodiments of the present disclosure is illustrated. In an implementation the method is performed by a system [100]. The method as depicted in FIG. 2 starts at step [202].

At step [204], the method comprises receiving, by a processing unit [102], at least one of a media content data, an entity data, and one or more target audience parameters. In an implementation, upon receiving an indication for automatically generating a target media, the processing unit may automatically receive from a storage unit such as from a storage unit [104], at least one of the media content data, the entity data, and the one or more target audience parameters. In another implementation, the processing unit may manually receive, (e.g., as one or more manual inputs from a backend operator of the system [100]), at least one of the media content data, the entity data, and the one or more target audience parameters. Also, the target media is one of an audio advertisement (ad) and an audio-visual ad.

Further, the media content data comprises at least one of an advertisement data and one or more input parameters. The advertisement data includes data related to an advertisement (ad) that is collected from one or more sources. The one or more sources may include such as, but not limited to, a customer relation management system, a sales data, one or more e-commerce platforms, one or more social media platforms, and/or such other sources as appreciated by a person skilled in the art in light of the present disclosure. Further, the collected data are analyzed to understand how well the ad is performing and optimize the ad. Also, the data collected from the one or more sources may include such as, but not limited to, an information related to at least one of a target audience, preference(s) of the target audience, an interest of the target audience in the ad(s), an interaction of the target audience with the ad(s) and such other data as appreciated by a person skilled in the art in light of the present disclosure.

Further, the one or more input parameters are received in a manual input, and the one or more input parameters comprise at least one of one or more media tone parameters, an input time duration parameter, and one or more action call parameters. The one or more media tone parameters include such as, but not limited to, at least one of an upbeat tone, an energetic tone, a wholesome tone, a dark tone, a normal tone, a sad, etc. Further, the input time duration parameter includes time duration such as, but not limited to, 10 sec, and/or 20 sec, etc., for generating a transcript for the target media to be generated and the one or more action call parameters includes parameters such as, but not limited to, at least one of a learn more action, a download now action, a click action, and a know more action, etc.

It is to be noted that the abovementioned the one or more media tone parameters, the input time duration parameter, and the one or more action call parameters are only exemplary and in no manner limiting the scope of the present disclosure. The one or more media tone parameters, the input time duration parameter, and the one or more action call parameters may include any other parameter(s) as appreciated by a person skilled in the art in light of the present disclosure.

Further, the entity data is a data related to one or more entities. The entity data may include data related to a market performance of the one or more entities or the data related to the performance of the one or more entities within the customers of the one or more entities. Each entity from the one or more entities is one of a brand entity and a product entity. Also, the entity data comprises at least one of an entity name of the one or more entities, an entity description of the one or more entities, one or more keywords associated with the one or more entities, and an URL associated with the one or more entities. Furthermore, the one or more target audience parameters comprise at least one of a target gender parameter (such as, male and/or female etc.) and a target age group parameter (such as 18-25 years, 30-35 years, and/or 50 years and above etc.).

Next, at step [206], the method comprises generating, by the processing unit [102], a background music based on at least one of the media content data, the entity data, the one or more target audience parameters, and a transcript. The transcript is generated based on at least one of the media content data, the entity data, and the one or more target audience parameters. Also, the processing unit utilises one or more artificial intelligence (AI) based language models to generate the transcript. For instance, in an implementation, the AI based language models may receive at least one of the media content data, the entity data, and the one or more target audience parameters in an audio format. The AI based language converts said received at least one of the media content data, the entity data, and the one or more target audience parameters into a textual format from the audio format. The converted textual format of said at least one of the media content data, the entity data, and the one or more target audience parameters may be used to generated at least one of the background music and an audio speech for the target media to be generated.

It is to be noted that the abovementioned audio format of at least one of the media content data, the entity data, and the one or more target audience parameters is only exemplary and in no manner limiting the scope of the present disclosure. Said at least one of the media content data, the entity data, and the one or more target audience parameters may be received in any other format as appreciated by a person skilled in art to implement the features of the present disclosure.

In an implementation, the transcript may be generated based on the one or more target audience parameters in a predefined text format comprising at least one or more keywords associated with the one or more entities. Considering an example, say a clothing brand wants to advertise its products. The brand particularly wants to target its male buyers between the age of 25-30 years. So, the target gender parameter is male, and the target age group parameter is 25-30 years. The AI based language model may receive said target gender parameter and said target age group parameter as an input (either automatically or manually), in an audio format. The AI based language model generates a transcript in a textual format based on said inputs by converting the said audio inputs into the textual format and this textual format of the inputs may be further used to generate at least one of the background music and an audio speech for the target media to be generated.

In another exemplary implementation of the present solution, the transcript may be generated for a predefined length based on at least the input time duration parameter. Considering an example, the AI based language model generates the transcript of maximum 1000 words based on the time duration of, say, 2 minutes received as the input time duration parameter.

In an implementation, the processing unit utilizes one or more AI based text-to-audio models for generating the background music. In an implementation, the background music may be generated based on at least one of a desired media tone parameter, the target age group parameter, and the input time duration parameter. For example, an energetic background music of 2 minutes is generated for the transcript generated of maximum 1000 words based on the received input time duration parameter for e.g., the time duration of 2 minutes, the target gender parameter male audience and target age group parameter 25-30 years as discussed in the abovementioned example.

Further, at step [208], the method comprises generating, by the processing unit [102], an audio speech based on at least one of the media content data, the entity data, the one or more target audience parameters, the transcript, and the background music. The processing unit utilizes one or more AI based text-to-speech models for generating the audio speech. The audio speech is generated in one or more voice types, wherein the one or more voice types comprises at least one of a male voice type, a female voice type and a child voice type. Considering the abovementioned example, the audio speech may be generated in the strong male voice type for the as the target gender parameter is male and target age parameter is 25-30 years.

Furthermore, at step [210], the method comprises generating automatically, by the processing unit [102], the target media based on at least the background music, and the audio speech. The target media is generated in a predefined format based on merging in a predefined manner the generated background music and the generated audio speech. The generated background music and the generated audio speech are merged in such a manner that a volume of the generated background music is lower than a volume of the generated audio speech so the focus of the target audience of the target media remains on the generated audio speech instead of the generated background music. Considering the abovementioned example, the target media, for the clothing brand targeting the adult males of the age group 25-30 years, is generated in the predefined format such as the target media is of maximum 4 Megabytes in size. It may have at least 320 kilobits per second media playback speed and the volume of the generated background music in the target media is lower than the volume of the generated audio speech in the target media (i.e., the volume of the energetic background music is lower than the volume of the audio speech of the strong male). The focus of the target audience i.e., the males of the age group 25-30 years remain on the generated audio speech in the target media, e.g., the strong male voice stating, say, “Style as a gentleman. Shop now and find your perfect style.”

Moreover, the method comprises generating a script, by the processing unit [102], based on one or more predefined protocol standards and the target media. The script comprises a data related to one or more media files, and a pre-defined tag of each media file from the one or more media files. Further, the script is related to at least one of a set of bitrates, a set of media, and a set of uniform resource locators (URLs). Also, a predefined protocol standard from the one or more predefined protocol standards is a Video Ad Serving Template (VAST) protocol standard.

Also, the method comprises streaming, by the processing unit to one or more user devices, the target media based on the script. Further, the one or more media files with the pre-defined tag(s) can be used directly to stream the one or more media files. Further, parser(s) such as an XML parser etc. may be used to generate a final output tag along with the one or more media files for the set of bitrates, companion image(s), and/or tracking URL(s).

In an implementation, the generated script may provide audio file(s), along with a VAST tag which may be directly used for advertising with an audio ad. Also, the XML parser(s) for VAST XML(s) may be used to generate a final output tag along with the audio file(s) for the set of bitrates, companion image(s), and/or tracking URL(s).

Thereafter, at step [212], the method terminates.

The present disclosure may also relate to a non-transitory computer readable storage medium storing one or more instructions for automatically generating a target media, the instructions include executable code which, when executed by one or more units of a system [100], causes a processing unit of the system to receive, at least one of a media content data, an entity data, and one or more target audience parameters. Also, the executable code when executed causes the processing unit to generate, a background music based on at least one of the media content data, the entity data, the one or more target audience parameters, and a transcript. Further, the executable code when executed causes the processing unit to generate, an audio speech based on at least one of the media content data, the entity data, the one or more target audience parameters, the transcript, and the background music. Thereafter, the executable code when executed causes the processing unit to generate automatically, the target media based on at least the background music, and the audio speech.

Therefore, the present disclosure provides a technical solution for automatically generating a target media. The present disclosure provides a significant technical advancement in the field of media generation such as an audio advertising, or an audio-visual advertising leveraging cutting-edge technologies to provide a highly sophisticated and automated system for personalized media generation. The technical effect of the present disclosure lies in its seamless integration of multiple components to produce compelling and customized media such as audio advertisements. By utilizing one or more artificial intelligence (AI) based language models engaging ad transcripts are generated, ensuring messages conveyed by the target media relating to one or more entities (e.g., brand entity and product entity) align with the preferences of specific target audience segments. The one or more AI based text-to-audio models enhances the impact of the target media by generating suitable audio tracks that matches each entity's, from the one or more entities, intended tone and style. Additionally, the one or more AI based text-to-speech models produces high-quality, natural-sounding speech that adapts to a script of an Ad that is to be generated, making the listening experience authentic and captivating. Based on the implementation of the features of the present disclosure a harmonious merger of speech with background music is achieved that enhances the professional output of the generated media. This technical advancement significantly reduces the time and resources required to create personalized media, providing a scalable and versatile solution for advertisers across various industries. Ultimately, the technical effect of the technical solution as disclosed in the present disclosure is a transformative enhancement in generation of personalised media such as the audio or audio-visual advertisement, empowering advertisers to effectively communicate their brand messages and improve brand engagement and conversion rates.

While considerable emphasis has been placed herein on the disclosed implementations, it will be appreciated that many implementations can be made and that many changes can be made to the implementations without departing from the principles of the present disclosure. These and other changes in the implementations of the present disclosure will be apparent to those skilled in the art, whereby it is to be understood that the foregoing descriptive matter to be implemented is illustrative and non-limiting.

We claim:

1. A method for automatically generating a target media, the method comprises:
receiving, by a processing unit, at least one of a media content data, an entity data, and one or more target audience parameters;
generating, by the processing unit, a background music based on at least one of the media content data, the entity data, the one or more target audience parameters, and a transcript;
generating, by the processing unit, an audio speech based on at least one of the media content data, the entity data, the one or more target audience parameters, the transcript, and the background music; and
generating automatically, by the processing unit, the target media based on at least the background music, and the audio speech.

2. The method as claimed in claim 1, wherein the target media is one of an audio advertisement (ad) and an audio-visual ad.

3. The method as claimed in claim 1, wherein the media content data comprises at least one of an advertisement data and one or more input parameters.

4. The method as claimed in claim 3, wherein the one or more input parameters are received in a manual input, and the one or more input parameters comprise at least one of one or more media tone parameters, an input time duration parameter, and one or more action call parameters.

5. The method as claimed in claim 1, wherein the entity data is a data related to one or more entities, and wherein each entity from the one or more entities is one of a brand entity and a product entity.

6. The method as claimed in claim 5, wherein the entity data comprises at least one of an entity name of the one or more entities, an entity description of the one or more entities, one or more keywords associated with the one or more entities, and an URL associated with the one or more entities.

7. The method as claimed in claim 1, wherein the one or more target audience parameters comprise at least one of a target gender parameter and a target age group parameter.

8. The method as claimed in claim 1, wherein the transcript is generated based on at least one of the media content data, the entity data, and the one or more target audience parameters.

9. The method as claimed in claim 1, the method further comprises utilizing, by the processing unit, one or more artificial intelligence (AI) based language models for generating the transcript, one or more AI based text-to-audio models for generating the background music, and one or more AI based text-to-speech models for generating the audio speech.

10. The method as claimed in claim 1, wherein the audio speech is generated in one or more voice types, wherein the one or more voice types comprises at least one of a male voice type, a female voice type and a child voice type.

11. The method as claimed in claim 1, wherein the target media is generated in a predefined format based on merging in a predefined manner the generated background music and the generated audio speech.

12. The method as claimed in claim 1, the method further comprises:
generating a script, by the processing unit, based on one or more predefined protocol standards and the target media, wherein the script comprises a data related to one or more media files, and a pre-defined tag of each media file from the one or more media files, and
streaming, by the processing unit to one or more user devices, the target media based on the script.

13. The method as claimed in claim 12, wherein the script is related to at least one of a set of bitrates, a set of media, and a set of uniform resource locators (URLs).

14. The method as claimed in claim 12, wherein a predefined protocol standard from the one or more predefined protocol standards is a Video Ad Serving Template (VAST) protocol standard.

15. A system for automatically generating a target media, the system comprises:
a processing unit; and
a storage unit connected to at least the processing unit, wherein the processing unit is configured to:
receive, at least one of a media content data, an entity data, and one or more target audience parameters;
generate, a background music based on at least one of the media content data, the entity data, the one or more target audience parameters, and a transcript;
generate, an audio speech based on at least one of the media content data, the entity data, the one or more target audience parameters, the transcript, and the background music; and
generate automatically, the target media based on at least the background music, and the audio speech.

16. The system as claimed in claim 15, wherein the target media is one of an audio advertisement (ad) and an audio-visual ad.

17. The system as claimed in claim 15, wherein the media content data comprises at least one of an advertisement data and one or more input parameters.

18. The system as claimed in claim 17, wherein the one or more input parameters are received in a manual input, and the one or more input parameters comprise at least one of one or more media tone parameters, an input time duration parameter, and one or more action call parameters.

19. The system as claimed in claim 15, wherein the entity data is a data related to one or more entities, and wherein each entity from the one or more entities is one of a brand entity and a product entity.

20. The system as claimed in claim 19, wherein the entity data comprises at least one of an entity name of the one or more entities, an entity description of the one or more entities, one or more keywords associated with the one or more entities, and an URL associated with the one or more entities.

21. The system as claimed in claim 15, wherein the one or more target audience parameters comprise at least one of a target gender parameter and a target age group parameter.

22. The system as claimed in claim 15, wherein the transcript is generated based on at least one of the media content data, the entity data, and the one or more target audience parameters.

23. The system as claimed in claim 15, wherein the processing unit is configured to utilise one or more artificial intelligence (AI) based language models for generating the transcript, one or more AI based text-to-audio models for generating the background music, and one or more AI based text-to-speech models for generating the audio speech.

24. The system as claimed in claim 15, wherein the audio speech is generated in one or more voice types, wherein the one or more voice types comprises at least one of a male voice type, a female voice type and a child voice type.

25. The system as claimed in claim 15, wherein the target media is generated in a predefined format based on merging in a predefined manner the generated background music and the generated audio speech.

26. The system as claimed in claim 15, wherein the processing unit is further configured to:
generate a script based on one or more predefined protocol standards and the target media, wherein the script comprises a data related to one or more media files, and a pre-defined tag of each media file from the one or more media files, and
stream, to one or more user devices, the target media based on the script.

27. The system as claimed in claim 26, wherein the script is related to at least one of a set of bitrates, a set of media, and a set of uniform resource locators (URLs).

28. The system as claimed in claim 26, wherein a predefined protocol standard from the one or more predefined protocol standards is a Video Ad Serving Template (VAST) protocol standard.

29. A non-transitory computer readable storage medium storing one or more instructions for automatically generating a target media, the instructions include executable code which, when executed by one or more units of a system, causes a processing unit of the system to:
receive, at least one of a media content data, an entity data, and one or more target audience parameters,
generate, a background music based on at least one of the media content data, the entity data, the one or more target audience parameters, and a transcript,
generate, an audio speech based on at least one of the media content data, the entity data, the one or more target audience parameters, the transcript, and the background music, and
generate automatically, the target media based on at least the background music, and the audio speech.
